(19) United States
(12) Patent Application Publication
(10) Pub. No.: US 2015/0049651 A1
(43) Pub. Date: Feb. 19, 2015

(54) DYNAMICALLY UPDATING FILTERING CONFIGURATION IN MODEM BASEBAND PROCESSING

(71) Applicant: QUALCOMM Incorporated, San Diego, CA (US)

(72) Inventors: Gautham HARIHARAN, Sunnyvale, CA (US); Pengkai ZHAO, San Jose, CA (US); Levent AYDIN, San Diego, CA (US); Mariam MOTAMED, Redwood City, CA (US); Alexei Yurievitch GOROKHOV, San Diego, CA (US)

(21) Appl. No.: 14/458,600

(22) Filed: Aug. 13, 2014

Related U.S. Application Data
(60) Provisional application No. 61/865,928, filed on Aug. 14, 2013.

(51) Int. Cl. H04L 5/14; H04W 24/08

(52) U.S. Cl. CPC H04L 5/1461; H04W 24/08
USPC 370/278

(57) ABSTRACT

Certain aspects of the present disclosure generally relate to wireless communications and, more particularly, to dynamically updating filtering configuration in modem baseband processing. A method is provided for wireless communications. The method may be performed, for example, by a user equipment (UE). The method generally includes detecting one or more conditions regarding one or more metrics of a received signal and updating, based on the detection, a configuration of one or more filters designed to mitigate an effect of spurious signals associated with (e.g., that fall within) a bandwidth of the received signal.

### CROSS-REFERENCE TO RELATED APPLICATION(S)

This application claims benefit of U.S. Provisional Patent Application Ser. No. 61/865,928, filed Aug. 14, 2013, which is herein incorporated by reference in its entirety.

### BACKGROUND

I. Field of the Disclosure

Certain aspects of the present disclosure generally relate to wireless communications and, more particularly, to dynamically updating filtering configuration in modem baseband processing.

II. Description of Related Art

Wireless communication networks are widely deployed to provide various communication services such as telephony, video, data, messaging, broadcasts, and so on. Such networks, which are usually multiple access networks, support communications for multiple users by sharing the available network resources. For example, one network may be a 3G (the third generation of mobile phone standards and technology) system, which may provide network service via any one of various 3G radio access technologies (RATs) including EVDO (Evolution-Data Optimized), 1×RTT (1 times Radio Transmission Technology, or simply 1×), W-CDMA (Wideband Code Division Multiple Access), UMTS-TDD (Universal Mobile Telecommunications System-Time Division Duplexing), HSPA (High Speed Packet Access), GPRS (General Packet Radio Service), or EDGE (Enhanced Data rates for Global Evolution). The 3G network is a wide area cellular telephone network that evolved to incorporate high-speed internet access and video telephony, in addition to voice calls. Furthermore, a 3G network may be more established and provide larger coverage areas than other network systems. Such multiple access networks may also include code division multiple access (CDMA) systems, time division multiple access (TDMA) systems, frequency division multiple access (FDMA) systems, orthogonal frequency division multiple access (OFDMA) systems, single-carrier FDMA (SC-FDMA) networks, 3^{rd} Generation Partnership Project (3GPP) Long Term Evolution (LTE) networks, and Long Term Evolution Advanced (LTE-A) networks.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and user terminals in a wireless network.

Certain aspects of the present disclosure generally relate to dynamically updating filtering configuration in modem baseband processing.

Certain aspects of the present disclosure provide a method for wireless communications by a user equipment (UE). The method generally includes detecting one or more conditions regarding one or more metrics of a received signal and updating, based on the detection, a configuration of one or more filters designed to mitigate an effect of spurious signals associated with (e.g., that fall within) a bandwidth of the received signal.

Certain aspects of the present disclosure provide an apparatus for wireless communications by a user equipment (UE). The apparatus generally includes means for detecting one or more conditions regarding one or more metrics of a received signal and means for updating, based on the detection, a configuration of one or more filters designed to mitigate an effect of spurious signals associated with (e.g., that fall within) a bandwidth of the received signal.

Certain aspects of the present disclosure provide an apparatus for wireless communications by a user equipment (UE). The apparatus generally includes at least one processor configured to: detect one or more conditions regarding one or more metrics of a received signal and update, based on the detection, a configuration of one or more filters designed to mitigate an effect of spurious signals associated with (e.g., that fall within) a bandwidth of the received signal. The apparatus generally also includes a memory coupled with the at least one processor.

Certain aspects of the present disclosure provide a computer readable medium having instructions stored thereon. The instructions are generally executable by one or more processors, for detecting one or more conditions regarding one or more metrics of a received signal and updating, based on the detection, a configuration of one or more filters designed to mitigate an effect of spurious signals associated with (e.g., that fall within) a bandwidth of the received signal.

Numerous other aspects are provided including methods, apparatus, systems, computer program products, and processing systems.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of a wireless communications network, in accordance with certain aspects of the present disclosure.

FIG. 2 illustrates a block diagram of an example access point (AP) and user terminals, in accordance with certain aspects of the present disclosure.

FIG. 3 illustrates example Long Term Evolution (LTE) 3.5 GHz frequency band assignments by band number, in accordance with certain aspects of the present disclosure.

FIG. 4 illustrates an example RFFE block diagram using a trap/notch inter-stage filter, in accordance with certain aspects of the present disclosure.

FIG. 5 illustrates an example simulated graph of throughput versus power for three filtering configurations, in accordance with certain aspects of the present disclosure.

FIG. 6 illustrates an example graph of throughput versus power test results for three chipsets using three filtering configurations, in accordance with certain aspects of the present disclosure.

FIG. 7 illustrates an example simulated graph of throughput versus power for two filtering configurations with spurious signals present, in accordance with certain aspects of the present disclosure.

FIG. 8 illustrates an example call flow/state diagram for dynamically switching between three filtering states, in accordance with certain aspects of the present disclosure.

FIG. 9 illustrates example operations for wireless communications by a UE, in accordance with certain aspects of the present invention.

FIG. 9A illustrates example components capable of performing the operations shown in FIG. 9, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Certain aspects of the present disclosure generally relate to wireless communications and, more particularly, to dynamically updating filtering configuration (e.g., dynamic toggling of notch filtering configuration) in modem baseband processing. A filter (e.g., a notch filter, bandpass filter, or a bandstop filter) may not pass certain narrow bandwidths of a receive chain bandwidth, in order to filter out spurious signals to improve throughput performance. However, at higher power, the filter may begin to degrade throughput performance. Thus, filter configurations may be dynamically adjusted based on certain defined metrics (e.g., received signal strength indicator (RSSI), signal-to-noise and interference ratio (SINR), or reference signal received power (RSRP)) passing (e.g., exceeding or falling below) a threshold. According to certain aspects, a hysteresis may be applied to the thresholds to prevent ping-ponging between filter states.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any aspect described herein as “exemplary” is not necessarily to be construed as preferred or advantageous over other aspects.

The techniques described herein may be used in combination with various wireless technologies such as Code Division Multiple Access (CDMA), Orthogonal Frequency Division Multiplexing (OFDM), Time Division Multiple Access (TDMA), Spatial Division Multiple Access (SDMA), Single Carrier Frequency Division Multiple Access (SC-FDMA), and so on. Multiple user terminals can concurrently transmit/receive data via different (1) orthogonal code channels for CDMA, (2) time slots for TDMA, or (3) sub-bands for OFDM. A CDMA system may implement IS-2000, IS-95, IS-856, Wideband-CDMA (W-CDMA), or some other standards. An OFDM system may implement Institute of Electrical and Electronics Engineers (IEEE) 802.11, IEEE 802.16, Long Term Evolution (LTE), or some other standards. A TDMA system may implement GSM or some other standards. These various standards are known in the art.

### An Example Wireless Communications System

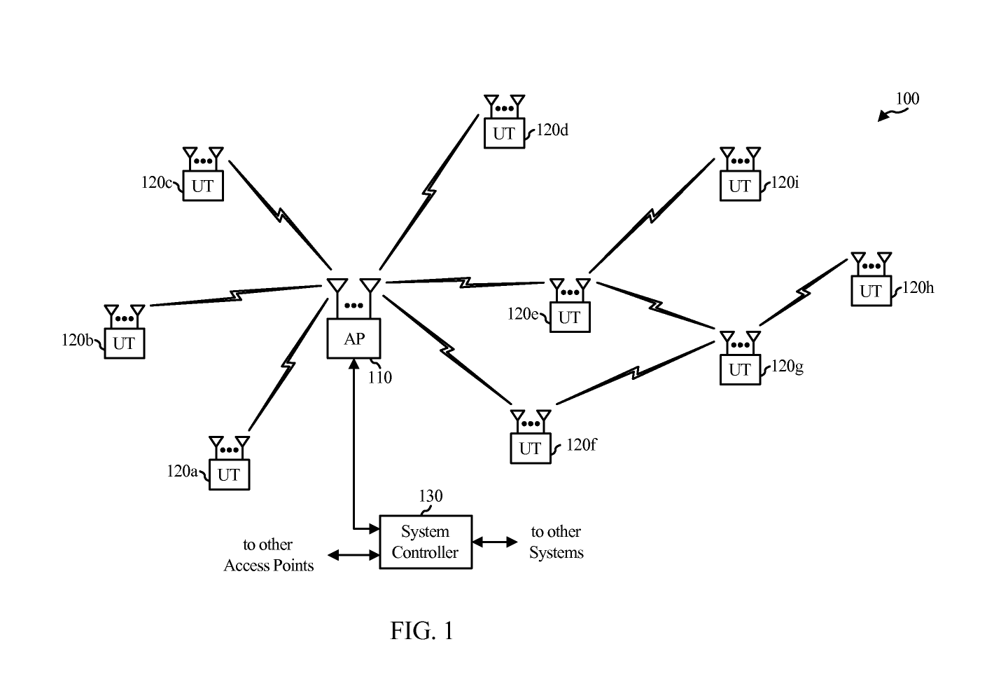

FIG. 1 illustrates a wireless communications system 100 with access points and user terminals. For simplicity, only one access point 110 is shown in FIG. 1. An access point (AP) is generally a fixed station that communicates with the user terminals and may also be referred to as a base station (BS), an evolved Node B (eNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

System 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≧1). The Nᵤ selected user terminals can have the same or different number of antennas.

Wireless system 100 may be a time division duplex (TDD) system or a frequency division duplex (FDD) system. For a TDD system, the downlink and uplink share the same frequency band. For an FDD system, the downlink and uplink use different frequency bands. System 100 may also utilize a single carrier or multiple carriers for transmission. Each user terminal may be equipped with a single antenna (e.g., in order to keep costs down) or multiple antennas (e.g., where the additional cost can be supported).

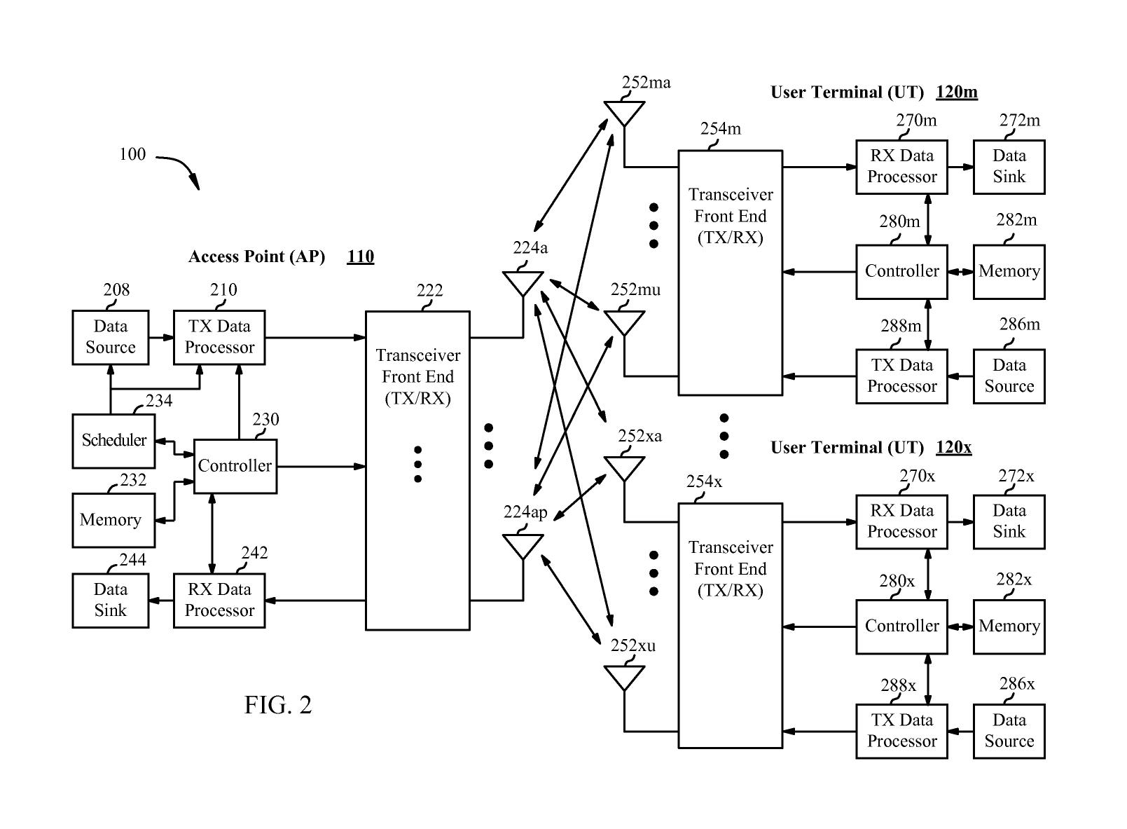

FIG. 2 shows a block diagram of access point 110 and two user terminals 120m and 120x in wireless system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ} for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the N_{ut,m} antennas for transmit diversity via an RF switch, for example. The controller 280 may control the routing within the transceiver front end 254.

A number Nᵤₚ of user terminals may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. For certain aspects of the present disclosure, a combination of the signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. An RX data processor 242 processes (e.g., demodulates, deinterleaves, and decodes) the recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222.

At each user terminal 120, N_{ut,m} antennas 252 receive the downlink signals from access point 110. For receive diversity at the user terminal 120, the transceiver front end 254 may select signals received from one of the antennas 252 for processing. For certain aspects of the present disclosure, a combination of the signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

Those skilled in the art will recognize the techniques described herein may be generally applied in systems utilizing any type of multiple access schemes, such as TDMA, SDMA, Orthogonal Frequency Division Multiple Access (OFDMA), CDMA, SC-FDMA, and combinations thereof

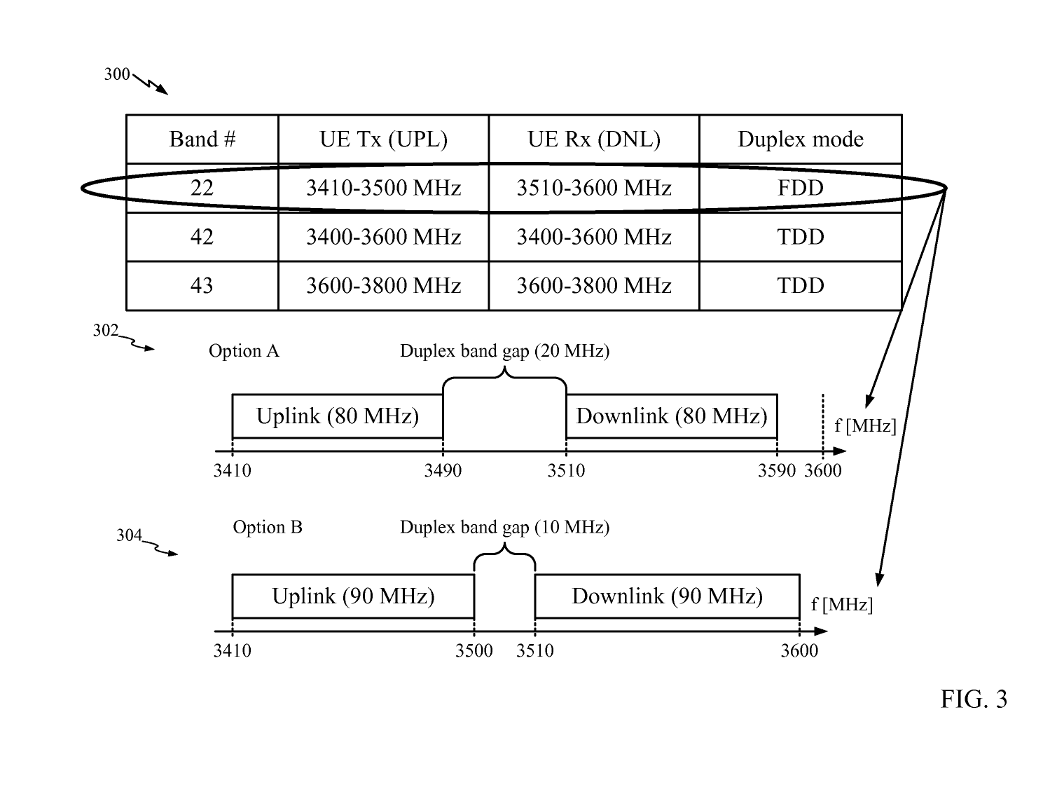

FIG. 3 illustrates a table 300 of example LTE 3.5 GHz frequency band assignments by band number. 3GPP TR 37.801 V0.10.0 (2011-01)—Paragraph 8.1.1 provides frequency band assignments for bands 22, 42, and 43, as illustrated in FIG. 3. For B22, at least two baseline options 302, 304 for uplink/downlink pairing assignment for FDD may exist. In a first option 302 (Option A), a 20 MHz duplex band gap may exist between an 80 MHz UE uplink frequency band (spanning frequencies from 3410 MHz to 3490 MHz) and an 80 MHz UE downlink frequency band (spanning frequencies from 3510 MHz to 3590 MHz). In a second option 304 (Option B), a 10 MHz duplex band gap may exist between a 90 MHz UE uplink frequency band (spanning frequencies from 3410 MHz to 3500 MHz) and a 90 MHz UE downlink frequency band (spanning frequencies from 3510 MHz to 3600 MHz).

### Example Filter

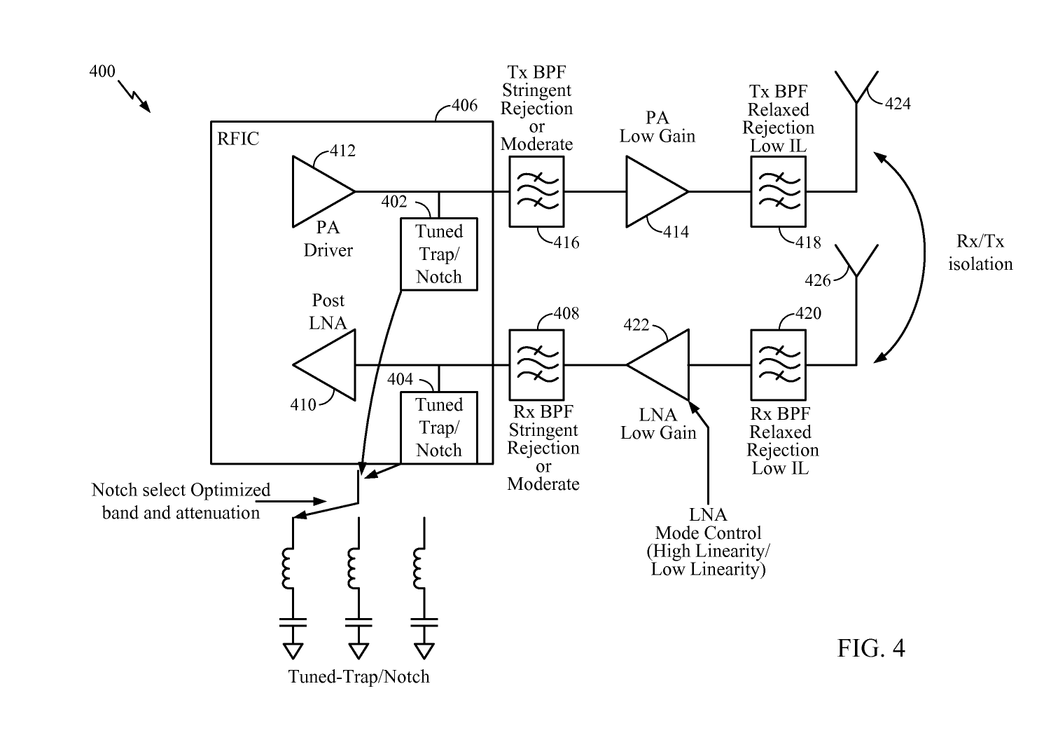

FIG. 4 illustrates an example RFFE block diagram 400 using a trap/notch inter-stage filter 402, 404, in accordance with certain aspects of the present disclosure. This tunable trap/notch filter 402, 404 may be added within the radio frequency integrated circuit (RFIC) 406 or external thereto. The tunable trap/notch filter 404 for the Rx path may be between the low noise amplifier (LNA) 408 and the post LNA 410, and the tunable trap/notch filter 402 for the Tx path may be between the power amplification (PA) driver 412 and the PA 414. One or both of the tunable trap/notch filters 402, 404 may comprise a switch for selecting between components (e.g., a series inductor and capacitor) with fixed values.

Specifications for the inter-stage band pass filters (BPFs) 416, 408 may be relaxed or may be kept stringent with the introduction of the trap/notch filters 402, 404. The notch inter-stage filter approach may include a relaxed front-end filter (e.g., BPF 418 in the Tx path and BPF 420 in the Rx path), which may permit lower power drive to the PA 414 and, thus, better mask emission in the Tx path. In the Rx path, a front-end filter (e.g., BPF 420) with relaxed specifications may improve Rx NF and, thus, sensitivity.

A tuned trap/notch filter may optimize, or at least increase, frequency rejection within the Rx-Tx band gap. Selection of the frequency band and attenuation for this optimization may be based on the Rx/Tx frequency of operation and/or the LTE resource block (RB) allocation and mode of operation. A tuned trap/notch filter may also permit a relaxed specification for the front-end (FE) BPF rejection, which may reduce interference loss (IL). This may save power in the Tx path and/or improve noise figure (NF) in the Rx path.

### Example Dynamic Updating of Filtering Configuration in Modem Baseband Processing

Filters, such as notch filters (e.g., trap/notch filter 402, 404 illustrated in FIG. 4), are typically used in modem baseband digital signal processing chains to mitigate the impact of spurious signals (also referred to as “SPURS”) that fall inside the signal bandwidth. Other filters may be used which mitigate impact of spurious signals that fall outside the signal bandwidth (e.g., a bandstop filter). A notch filter may allow (e.g, pass) a bandwidth including a signal of interest but suppress (e.g., not pass) certain narrow frequency ranges which may include spurious signals.

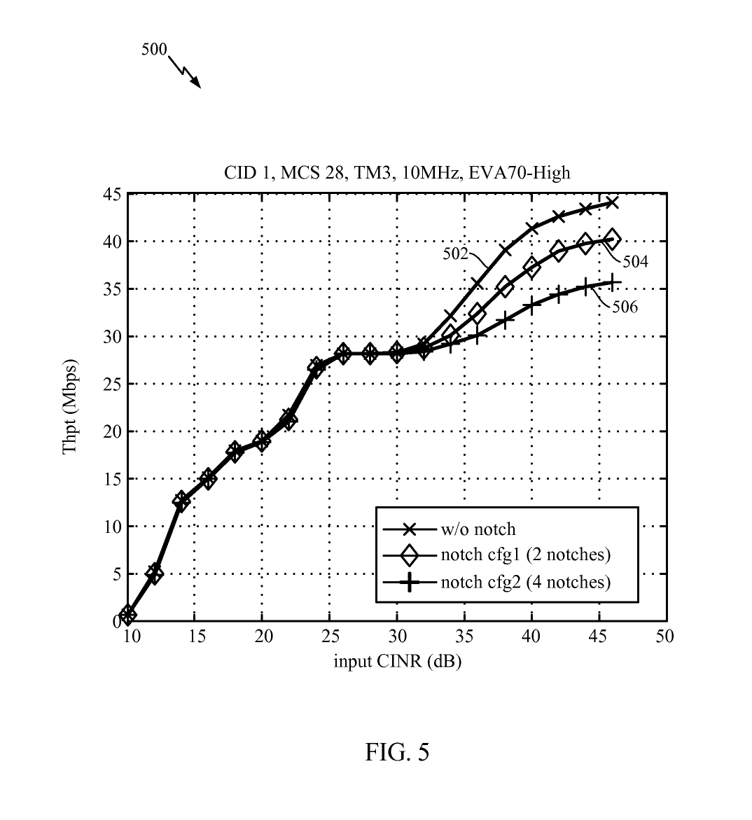

The use of such filters may degrade modem receiver performance, for example, when the signal is under good conditions (e.g., with no SPURS or high signal to noise ratio (SNR)). FIG. 5 illustrates an example simulated graph 500 of throughput versus power for three filtering configurations, in accordance with certain aspects of the present disclosure. The example simulated graph 500 illustrates performance degradation due to use of filters at high SNR where no spurious signals are present. FIG. 5 represents a simulation where the modulation coding scheme (MCS) is 28, for 10 MHz long term evolution (LTE), transmission mode 3 (TM3), and channel: EVA70, high correlation, where no spurious signals present. Throughput (in Mb/s) is shown on the vertical axis and SNR (in dB) is shown on the horizontal axis. Receiver throughput is simulated for three filtering configurations. Curve 502 represents the throughput for a receiver that does not use a notch filter. Curve 504 represents the throughput for a receiver that uses two notch filters. And curve 506 represents the throughput for a receiver that uses four notch filters. As shown in FIG. 5, throughput loss is observed in the high SNR regime—around 33 dB and higher. For example, at around 46 dB, the throughput for curve 502 having no notch filter is around 44 Mb/s, the throughput for curve 504 having two notch filters is around 40 Mb/s, and the throughput for curve 506, which uses four notch filters, is around 36 Mb/s.

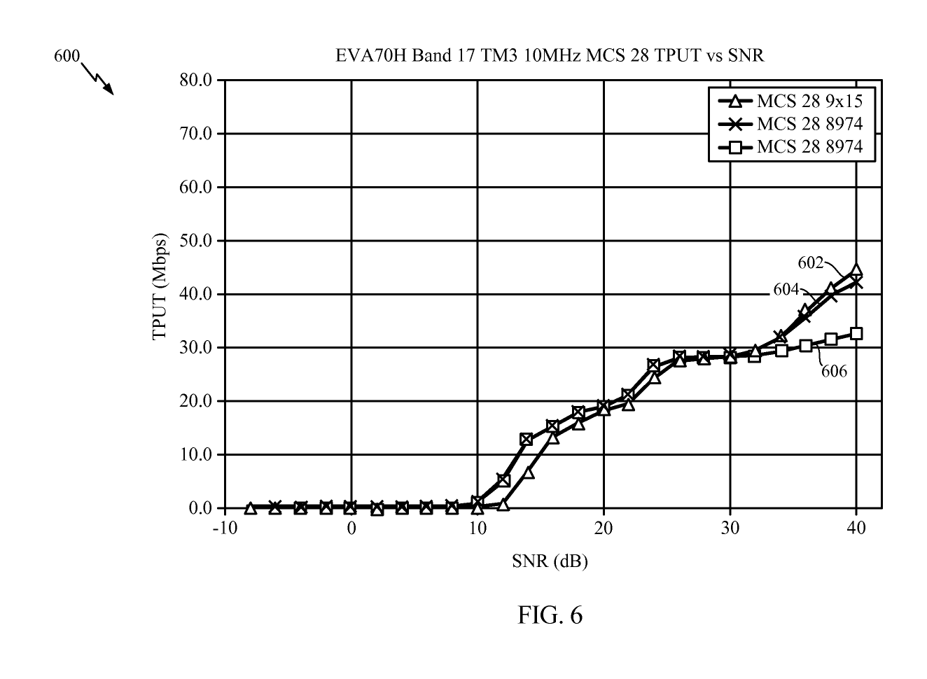

FIG. 6 illustrates an example graph 600 of throughput versus power test results for three chipsets using three filtering configurations, in accordance with certain aspects of the present disclosure. FIG. 6 illustrates results from an actual chipset test under the same parameters as those simulated in FIG. 5. Curve 602 and curve 604 represent the throughput for chipsets that do not use a notch filter (e.g., notch filter disabled). Curve 606 represents the throughput for a chipset that uses notch filters (e.g., notch filters enabled). As shown in FIG. 6, throughput loss is observed in the high SNR regime—around 32 dB and higher. For example, at around 40 dB, the throughput for curve 602 and the curve 604 which do not use notch filters are around 44 Mb/s and 42 MB/s, respectively, while the throughput for curve 606 which uses notch filters is around 32 Mb/s.

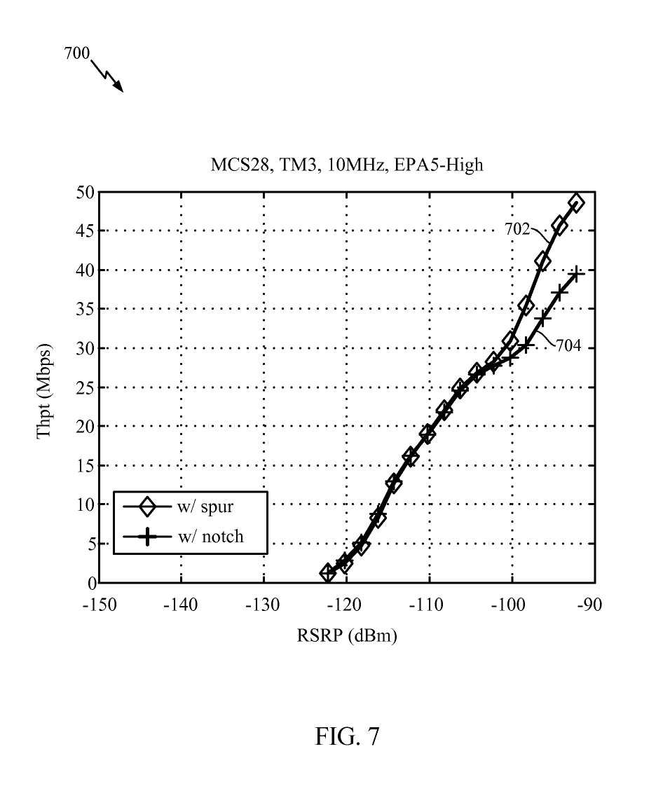

FIG. 7 illustrates an example simulated graph 700 of throughput versus power for two filtering configurations with spurious signals present, in accordance with certain aspects of the present disclosure. FIG. 7 illustrates throughput degradation at high power, even in the case that spurious signals are present, when notch filtering is employed. Example simulated graph 700 represents a simulation where the MCS is 28, for 10 MHz LTE, TM3, and channel: EPA5, high correlation, where spurious signals present. Throughput (in Mb/s) is shown on the vertical axis and reference signal received power (RSRP) (in dBm) is shown on the horizontal axis. Receiver throughput is simulated for two filtering configurations. Curve 702 represents the throughput for a receiver that does not use a notch filter—where spurious signals are present. Curve 704 represents the throughput for a receiver that uses notch filter(s)—where spurious signals are present. As shown in FIG. 7, throughput loss is observed in the high power regime—around −105 dBm and higher. For example, at around −92 dBm, while throughput for curve 702 having no notch filter—and with spurious signals present—is around 49 Mb/s and the throughput for curve 704 which uses notch filter(s) is around 39 Mb/s. However, as shown in FIGS. 5-7, notch filtering is useful for low power scenarios.

Additionally, the performance impact from spurious signals may be a concern for low receive (Rx) power (e.g., between 10-15 dB and/or other ranges) scenarios (e.g., user terminals near the edge of a cell) and scenarios where the receiver is close to reference sensitivity (e.g., the minimum specified performance level). The impact of spurious signals may be negligible when the receiver operates in any other scenario (e.g., high power/throughput (tput)). Thus, in scenarios where the impact of spurious signals is low or negligible, use of a filter may not be desirable for optimal receiver performance.

The proposed methods and apparatus reduce or eliminate the performance impact from spurious signals without degrading, or while limiting degradation of, receiver performance, by dynamically configuring the state of one or more filters (e.g., notch filters) based on appropriate metric(s) from the receiver. Certain aspects of the present methods and apparatus provide for dynamic toggling of notch filter configuration in modem baseband processing.

As discussed above, a filter (e.g., a notch filter, bandpass filter, or a bandstop filter which may be similar to trap/notch filter 402, 404) may not pass certain narrow bandwidths of a receive chain bandwidth, in order to filter out spurious signals to improve performance. However, at higher power, the filter may begin to degrade throughput performance (e.g., as illustrated in FIGS. 5-7). Thus, filter configurations may be dynamically adjusted based on certain defined metrics (e.g., receiver metrics) exceeding or falling below a threshold. A hysteresis may be applied to the thresholds to prevent ping-ponging between filter states. According to certain aspects, the various filtering states may include a state where no filters are used or where no filters of a certain type are used. For example, in one example state, notch filters and/or bandstop filters may not be used (e.g., disabled). Additionally or alternatively, the various filtering states may include states where various number of filters are used or where various numbers of certain types of filters are used. For example, various example states may include states where various numbers of notch filters and/or bandstop filters are used (e.g., enabled).

According to certain aspects, a filter (e.g., notch filter, bandpass filter, bandstop filter, trap which may be similar to trap/notch filter 402, 404) state may be dynamically switched from a first state to a second state based on operating conditions (e.g., receiver metrics). For example, the filter state may be switched based on received signal strength indicator (RSSI), signal-to-noise and interference ratio (SINR), reference signal received power (RSRP), and/or the like.

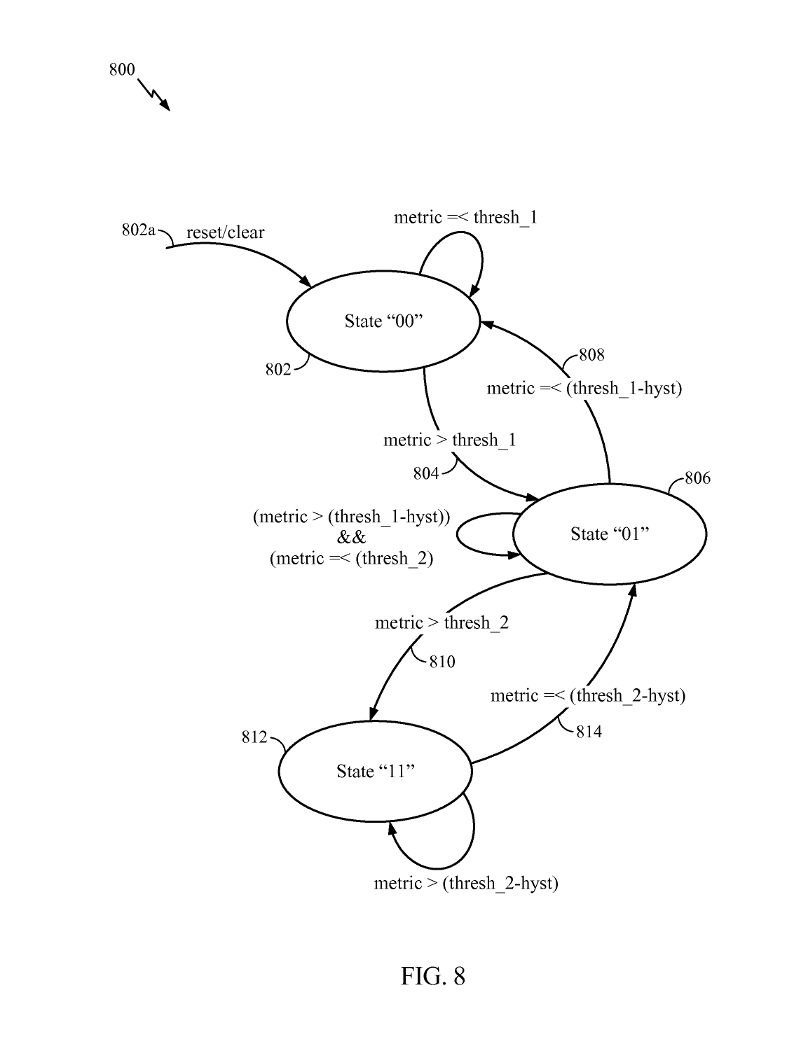

According to certain aspects, a state machine may be employed in hardware, software (SW), firmware (FW), and/or the like, that has (e.g., straddles) multiple states, each state corresponding to a notch filter configuration. FIG. 8 illustrates an example call flow/state diagram 800 for dynamically switching between a plurality of (e.g., three) filtering states, in accordance with certain aspects of the present disclosure. As shown in FIG. 8, filtering may be configured in one of the three filtering states: 00, 01, or 11. According to certain aspects, the filtering may be configured with any number of different filtering states. As shown in the example in FIG. 8, at 802, the filtering may begin in a first filtering state 00. According to certain aspects, alternatively, at 802a, the filtering may be reset or cleared to the first filtering state 00. At 804, while in the first filtering state 00, if a metric (e.g., a receiver metric) or combination of metrics exceeds a first threshold (e.g., thresh_{—}1), the filtering may be updated (e.g., toggled), at 806, to a second filtering state 01. While in the second filtering state 01, if the metric falls back below the first threshold, at 808, the filtering may be updated to (e.g., toggled back to) the first filtering state 00. However, at 810, while in the second filtering state 01, if the metric reaches a second threshold (e.g., thresh_{—}2), at 812, the filtering may be updated (e.g., toggled) to a third filtering state 11. While in the third filtering state 11, if the metric falls back below the second threshold, at 814, the filtering may be updated to (e.g., toggled back to) the second filtering state 01.

According to certain aspects, power and/or time hysteresis may be built into the state transitions. This may prevent the filtering from “ping-ponging” back and forth between two states if the metric fluctuates around the threshold. For example, for a power hysteresis, the power may exceed or drop below the threshold by some fraction of the threshold before the filtering toggles to the next state. As another example, for time hysteresis, the power may exceed or drop below the threshold for a specified duration before the filtering toggles to the next state. FIG. 8 illustrates a built in hysteresis corresponding to the metric (which may include time and/or power) and/or combination of metrics. As shown in FIG. 8, the filtering is only updated when the metric exceeds or falls below the threshold by a specified hysteresis amount.

According to certain aspects, the first filtering state 00 may correspond to a filtering configuration that uses multiple filters (e.g., notch filter, bandstop filter, trap which may be similar to trap/notch filter 402, 404), the second filtering state 01 may correspond to a filtering configuration that uses less filters, and the third filtering state 11 may correspond to a filtering state that uses no filters. According to certain aspects, the first filtering state 00, the second filtering state 01, and the third filtering state 11 may correspond to any combination of filtering configurations using number of filters and/or no filters.

According to certain aspects, a receive chain may have a number of filters based on (e.g., equal to) the number of spurious signals in the bandwidth. According to certain aspects, a number of such thresholds may be an adjustable parameter. In an example implementation, there may be a different threshold per filter—which may provide flexibility. In another example implementation, there may be one threshold per receive chain (e.g., the same threshold may be used for a subset or group of filters associated with the same receive chain)—which may be less flexible, but simpler to manage in a receiver.

According to certain aspects, although the invention is described using LTE as an example, the proposed solution may be applicable in general to all wireless technologies.

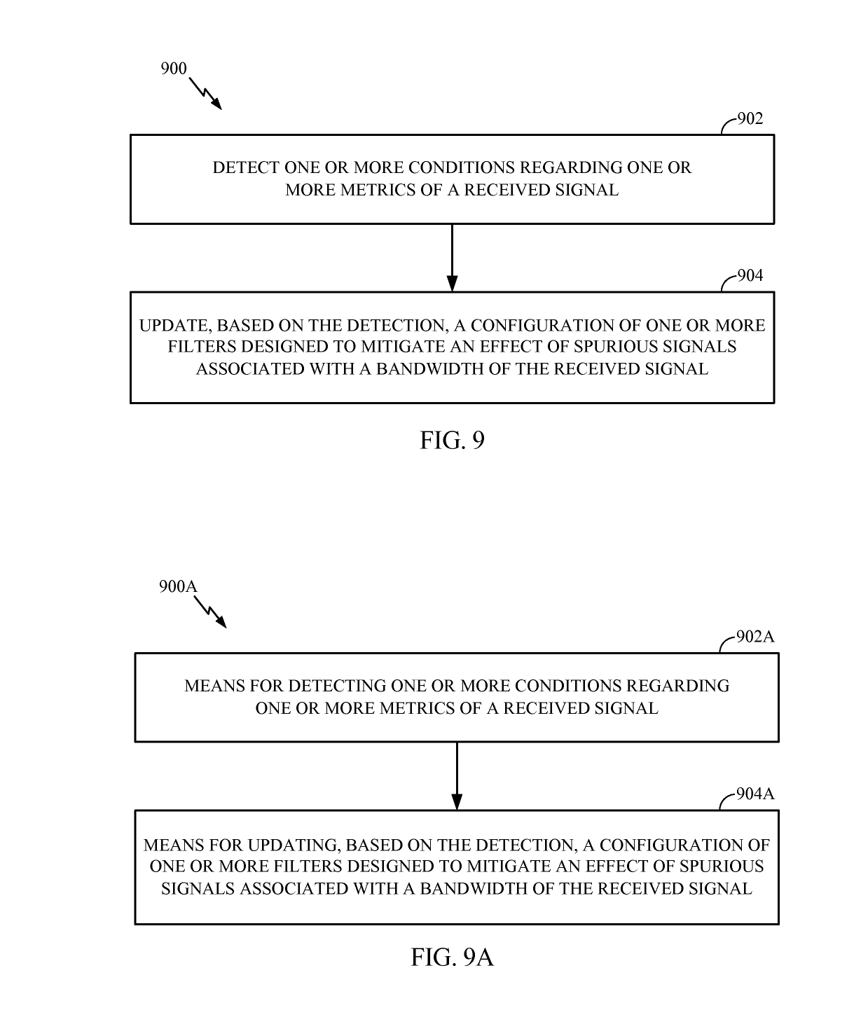

FIG. 9 illustrates example operations 900 for wireless communications, in accordance with certain aspects of the present invention. The operations 900 may be performed, for example, by a UE (e.g., user terminal 120). The operations 900 may begin, at 902, by detecting one or more conditions regarding one or more metrics of a received signal (e.g., RSSI, SINR, and/or RSRP). For example, the UE may detect that the one or more metrics has passed a threshold.

At 904, the UE may update, based on the detection, a configuration of one or more filters (e.g., notch filter and/or bandstop filter) designed to mitigate an effect of spurious signals that are associated with (e.g., fall within a bandwidth) of the received signal. According to certain aspects, one or more portions of the spurious signals may fall outside the bandwidth. According to certain aspects, the configuration may include one filter for each spurious signal in the bandwidth. According to certain aspects, a state machine may adjust the filtering configuration by enabling or disabling filters or by widening or narrowing the portion of filtered bandwidth for one or more of the filters. For example, the state machine may adjust (e.g., dynamically adjust during operation) the filtering configurations if one of the metrics exceed or fall below a threshold.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations or methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for transmitting may comprise a transmitter (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for receiving may comprise a receiver (e.g., the transceiver front end 254 of the user terminal 120 depicted in FIG. 2 or the transceiver front end 222 of the access point 110 shown in FIG. 2) and/or an antenna (e.g., the antennas 252ma through 252mu of the user terminal 120m portrayed in FIG. 2 or the antennas 224a through 224ap of the access point 110 illustrated in FIG. 2). Means for processing or means for determining may comprise a processing system, which may include one or more processors, such as the RX data processor 270, the TX data processor 288, and/or the controller 280 of the user terminal 120 illustrated in FIG. 2.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 900 illustrated in FIG. 9 correspond to means 900A illustrated in FIG. 9A.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise.

According to certain aspects, such means may be implemented by processing systems configured to perform the corresponding functions by implementing various algorithms (e.g., in hardware or by executing software instructions). For example, an algorithm for wireless communications may detect one or more conditions regarding one or more metrics of a received signal. Then, the algorithm may include updating, based on the detection, a configuration of one or more filters designed to mitigate an effect of spurious signals associated with a bandwidth of the received signal.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, the instructions may be executed by a processor or processing system of the user terminal 120 or access point 110 and stored in a memory 210 of the user terminal 120 or memory 232 of the access point 110. For example, the computer-readable medium may have computer executable instructions stored thereon for detecting one or more conditions regarding one or more metrics of a received signal and computer executable instructions stored thereon for updating, based on the detection, a configuration of one or more filters designed to mitigate an effect of spurious signals associated with a bandwidth of the received signal. For certain aspects, the computer program product may include packaging material.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for wireless communication by a user equipment (UE), comprising:
detecting one or more conditions regarding one or more metrics of a received signal; and
updating, based on the detection, a configuration of one or more filters designed to mitigate an effect of spurious signals associated with a bandwidth of the received signal.

2. The method of claim 1, wherein the spurious signals associated with the bandwidth of the received signal fall within the bandwidth of the received signal or do not fall within the bandwidth of the received signal.

3. The method of claim 1, wherein the one or more metrics comprises at least one of: received signal strength indicator (RSSI), signal-to-noise and interference ratio (SINR), or reference signal received power (RSRP).

4. The method of claim 1, wherein detecting the one or more conditions regarding the one or more metrics of the received signal includes detecting the one or more metrics passes a threshold.

5. The method of claim 1, wherein the one or more filters comprises at least one of: a bandpass filter or a notch filter.

6. The method of claim 5, wherein a number of the one or more filters is based on a number of spurious signals in the bandwidth of the received signal.

7. The method of claim 1, wherein updating the configuration comprises at least one of: enabling or disabling one or more of the one or more filters.

8. The method of claim 1, wherein updating the configuration comprises adjusting a portion of a bandwidth to be filtered out.

9. The method of claim 1, wherein the updating is performed based on a state machine having a plurality of states defined by the one or more conditions.

10. The method of claim 9, wherein the plurality of states are defined by values of the one or more metrics relative to one or more threshold values.

11. The method of claim 10, wherein the one or more threshold values comprise different threshold values for different filters.

12. The method of claim 10, wherein the one or more threshold values comprises a threshold value for a group of filters.

13. The method of claim 10, wherein the one or more threshold values comprises a threshold value per receive chain of the UE.

14. The method of claim 10, wherein the one or more threshold values are selected to provide hysteresis in updating the plurality of states.

15. The method of claim 10, further comprising limiting how often the plurality of states are updated in a given time period.

16. An apparatus for wireless communication by a user equipment (UE), comprising:
means for detecting one or more conditions regarding one or more metrics of a received signal; and
means for updating, based on the detection, a configuration of one or more filters designed to mitigate an effect of spurious signals associated with a bandwidth of the received signal.

17. The apparatus of claim 16, wherein the spurious signals associated with the bandwidth of the received signal fall within the bandwidth of the received signal or do not fall within the bandwidth of the received signal.

18. The apparatus of claim 16, wherein the one or more metrics comprises at least one of: received signal strength indicator (RSSI), signal-to-noise and interference ratio (SINR), or reference signal received power (RSRP).

19. The apparatus of claim 16, wherein detecting the one or more conditions regarding the one or more metrics of the received signal includes detecting the one or more metrics passes a threshold.

20. The apparatus of claim 16, wherein the one or more filters comprises at least one of: a bandpass filter or a notch filter.

21. The apparatus of claim 20, wherein a number of the one or more filters is based on a number of spurious signals in the bandwidth of the received signal.

22. The apparatus of claim 16, wherein updating the configuration comprises at least one of: enabling or disabling one or more of the one or more filters.

23. The apparatus of claim 16, wherein updating the configuration comprises adjusting a portion of a bandwidth to be filtered out.

24. The apparatus of claim 16, wherein the updating is performed based on a state machine having a plurality of states defined by the one or more conditions.

25. The apparatus of claim 24, wherein the plurality of states are defined by values of the one or more metrics relative to one or more threshold values.

26. The apparatus of claim 25, wherein the one or more threshold values comprise different threshold values for different filters.

27. The apparatus of claim 25, wherein the one or more threshold values comprises a threshold value for a group of filters.

28. The apparatus of claim 25, wherein the one or more threshold values are selected to provide hysteresis in updating the plurality of states.

29. An apparatus for wireless communication by a user equipment (UE), comprising:
at least one processor configured to:
detect one or more conditions regarding one or more metrics of a received signal; and
update, based on the detection, a configuration of one or more filters designed to mitigate an effect of spurious signals associated with a bandwidth of the received signal; and
a memory coupled with the at least one processor.

30. A computer readable medium having instructions stored thereon, the instructions executable by one or more processors, for:
detecting one or more conditions regarding one or more metrics of a received signal; and
updating, based on the detection, a configuration of one or more filters designed to mitigate an effect of spurious signals associated with a bandwidth of the received signal.
